(19) United States
(12) Patent Application Publication
(10) Pub. No.: US 2026/0192589 A1
(43) Pub. Date: Jul. 9, 2026

(54) SECURITY DOCUMENT WITH FUNCTIONAL WATERMARK AND METHODS FOR MAKING SAME

(71) Applicant: Crane & Co., Inc., Dalton, MA (US)

(72) Inventors: Michael Darroch, Dalton, MA (US); Paul Mirto, Pittsfield, MA (US); Jeffrey Scot Royal, Belchertown, MA (US); Giles D. Prett, Dalton, MA (US); Steven Lukaszek, Pittsfield, MA (US)

(21) Appl. No.: 19/132,367

(22) PCT Filed: Nov. 30, 2023
(86) PCT No.: PCT/US2023/081894

§ 371 Date: May 22, 2025

Related U.S. Application Data
(60) Provisional application No. 63/386,832, filed on Dec. 9, 2022.
(60) Provisional application No. 63/588,680, filed on Oct. 6, 2023.

(51) Int. Cl. B42D 25/333; B42D 25/355; B42D 25/425; B42D 25/47

(52) U.S. Cl. CPC B42D 25/333; B42D 25/355; B42D 25/425; B42D 25/47

(57) ABSTRACT

A security document includes a fibrous substrate, the fibrous substrate including a functional watermark including a defined region of altered fiber density relative to a bulk portion of the fibrous substrate, wherein the functional watermark comprises a first edge defining, at least in part, a shape of the defined region of altered fiber density. The security document further includes a surface applied security device covering at least part of the defined region of altered fiber density relative to the bulk portion.

### CROSS-REFERENCE TO RELATED APPLICATIONS

This application is a 371 National Stage of International Application No. PCT/US2023/081894, filed Nov. 30, 2023, which claims priority to U.S. Provisional Patent Application Nos. 63/588,680, filed Oct. 6, 2023, and 63/386,832, filed Dec. 9, 2022, the disclosures of which are incorporated herein by reference.

### TECHNICAL FIELD

The present disclosure relates to enhancing the counterfeit resistance of security documents, such as currency notes, passports and other documents comprising surface-applied micro-optic security devices. More specifically, this disclosure relates to a security document with one or more functional watermarks and methods for producing same.

### BACKGROUND

Manufacturing passports, banknotes, and other documents (referred to herein as “security documents”) whose constructional features include hard-to-reproduce indicia of the documents' authenticity against counterfeiting remains an ongoing source of technical challenges and opportunities for improvement in the field of security document design.

The challenges associated with manufacturing security documents of the quality expected by, for example, central banks and passport offices, include reconciling the need for fast, high-speed manufacturing with consistency and high-quality control. Put differently, any manufacturing or quality control issues with legitimate security documents provide cover for malicious actors to pass off imperfect copies as the genuine documents. Thus, the security of security documents depends, at least in part, on newly-issued legitimate documents being as uniform and defect-free as possible.

### SUMMARY

The present disclosure illustrates embodiments of a security document with a functional watermark and methods for making same.

In a first embodiment, a security document includes a fibrous substrate. The fibrous substrate includes a functional watermark. The functional watermark includes a defined region of altered fiber density relative to a bulk portion of the fibrous substrate, wherein the functional watermark comprises a first edge defining, or determining, at least in part, a shape of the defined region of altered fiber density. The security document further includes a surface applied security device covering at least part of the defined region of altered fiber density relative to the bulk portion.

In a second embodiment, a method of making a security document includes forming an initial fibrous web from a wet fibrous slurry, altering the fiber density of the initial fibrous web in one or more defined regions to define one or more functional watermarks, pressing and drying the initial fibrous web to form a fibrous substrate comprising a bulk portion and the one or more functional watermarks, wherein the one or more functional watermarks comprise at least one of a light element or a dark element, the light element or dark element having at least one edge bounding a region of altered fiber density and applying a surface applied security device covering at least part of the one or more functional watermarks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A-1E illustrate examples of nail defects, and the regions they arise, on an uncut sheet of security documents;

FIG. 2 illustrates an example of functional edge watermarks as viewed on a partial sheet of uncut security documents in accordance with this disclosure;

FIGS. 3A and 3B illustrate examples of functional edge watermarks in accordance with this disclosure;

FIG. 4 illustrates an example method for producing a security document having a functional edge watermark from a stack of uncut sheets of security documents in accordance with this disclosure;

FIG. 5 illustrates an example of a security document in accordance with this disclosure;

FIG. 6 illustrates an example of a security feature in accordance with this disclosure;

FIG. 7 illustrates an example of an uncut section of a fibrous substrate containing multiple functional watermarks, in accordance with this disclosure;

FIG. 8 illustrates six examples of functional watermark patterns relative to a plurality of peel vectors in accordance with this disclosure;

FIGS. 9A and 9B illustrate an example harvesting test of a security document containing a functional watermark in accordance with this disclosure;

FIG. 10 illustrates an example harvesting test of a security document containing a functional watermark in accordance with this disclosure;

FIG. 11 illustrates an example harvesting test of a security document containing a functional watermark in accordance with this disclosure; and

FIG. 12 illustrates an example method for producing a security document comprising one or more functional watermarks in accordance with this disclosure.

### DETAILED DESCRIPTION

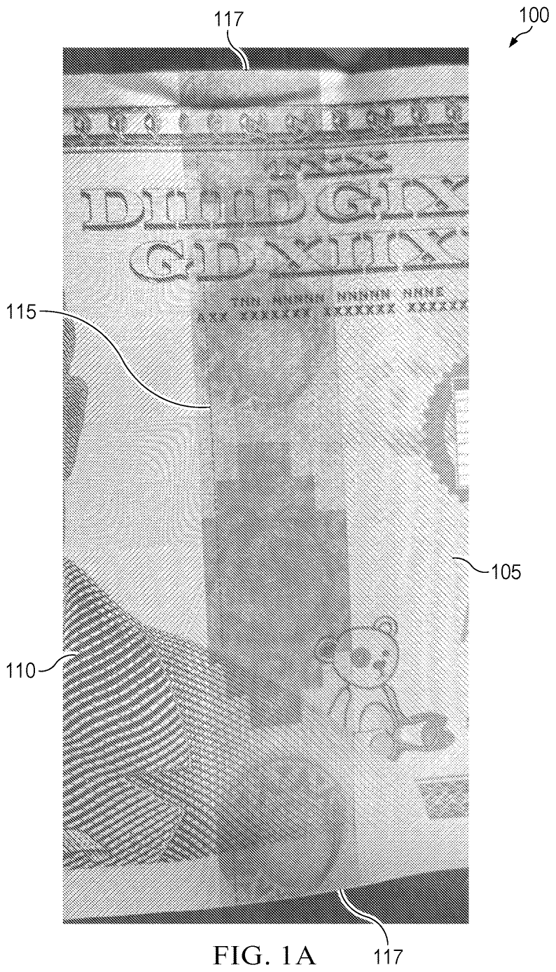

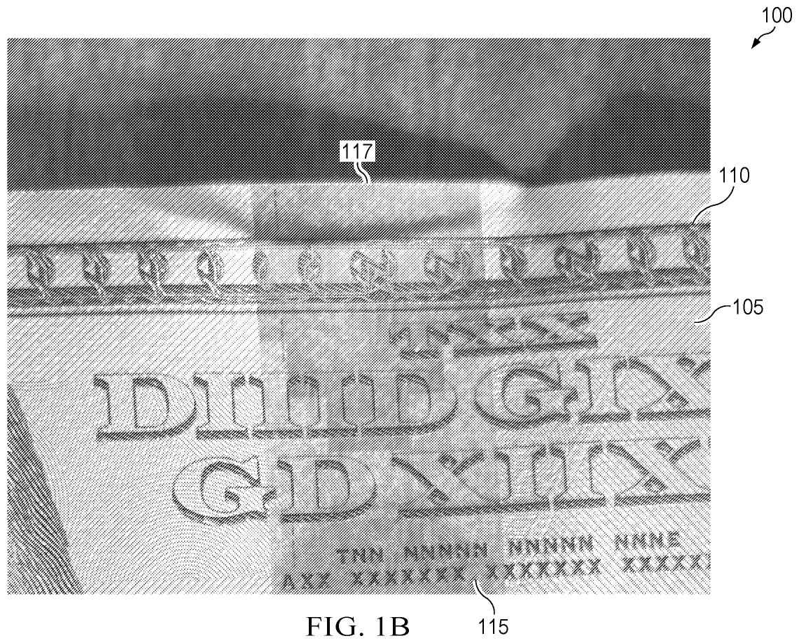

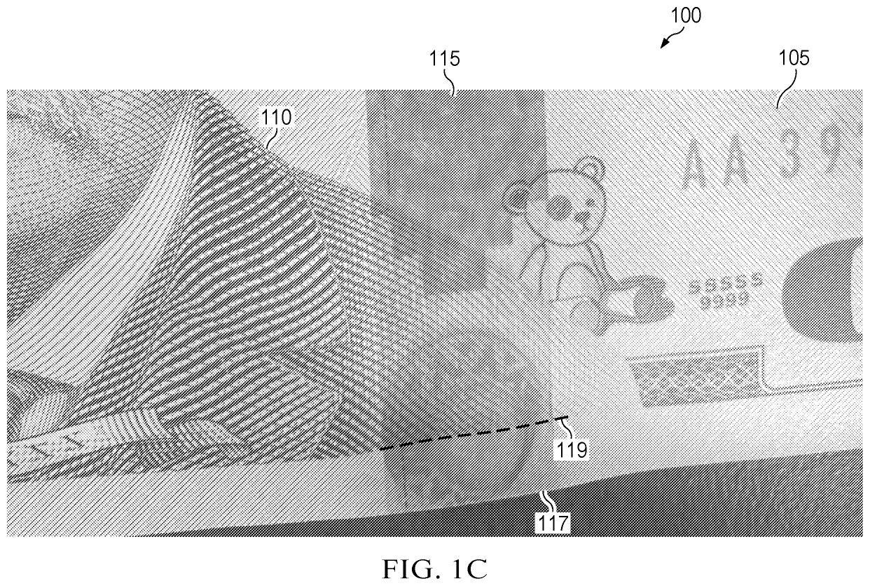

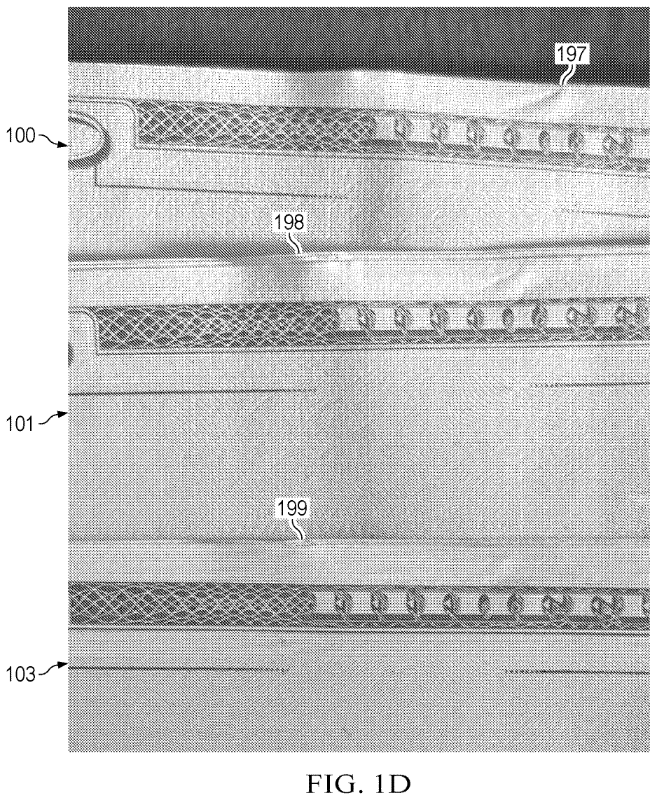

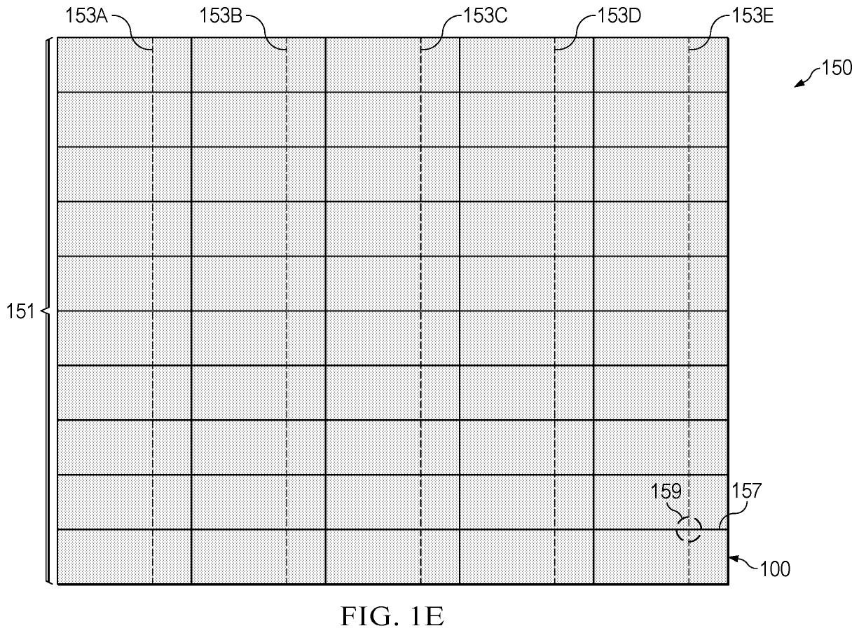

FIGS. 1A through 12, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompass such changes and modifications as falling within the scope of the claims.

As noted above, manufacturing passports, banknotes, and other documents (referred to herein as “security documents”) whose constructional features include hard-to-reproduce indicia of the documents' authenticity against counterfeiting remains an ongoing source of technical challenges and opportunities for improvement in the field of security document design.

The challenges associated with manufacturing security documents of the quality expected by, for example, central banks and passport offices, include reconciling the need for fast, high-speed manufacturing with consistency and high-quality control. Put differently, any manufacturing or quality control issues with legitimate security documents provide cover for malicious actors to pass off imperfect copies as the genuine documents. Thus, the security of security documents depends, at least in part, on newly-issued legitimate documents being as uniform and defect-free as possible.

The manufacturing challenges associated with making defect-free security documents at scale and at speed include, without limitation, minimizing the incidence of what are known as “nail defects.” Many security documents, including currency notes, are manufactured, at least in part, on roll-to-roll processes to produce uncut sheets (for example, the 4-, 8-, 16- or 50-bill uncut currency sheets sold by the United States mint) with multiple security documents on the sheet. In operations where security documents are produced at size and scale, the uncut sheets are assembled into a stack of predetermined size (also known as a “belt”) and cut using a pressure-driven, guillotine-like blade that simultaneously compresses and cuts the stacked documents along one or more predetermined cut lines.

Often, applied security features (for example, surface-applied or embedded strips of micro-optic material) intersect the cut lines along which individual security documents are cut from a larger sheet. Further, applied security features are often made of polyethylene in conjunction with resinous materials which have significantly dissimilar compressibility and deformation properties than the paper or fibrous substrates to which they are attached. As such, when the leading edge of a cutting tool progresses along the cut line of a belt of uncut security documents and reaches the point where a security feature transects the cut line, the relative incompressibility of the overlapping security features in the stack creates local discontinuities and variations in the cutting force necessary to propagate the cut through the less compressible security features. The local discontinuities in the material properties of the stack being cut in the region around the security features give rise to what is known in the industry as a “nail defect,” which typically presents as a crinkling and deformation of the paper substrate and of the security feature at the cut edge of the security document. This effect is multiplied as the number of uncut sheets in the belt increases.

While instances of “nail defects” can be reduced somewhat by increased replacement and resharpening of cutting blades or by putting fewer uncut sheets in a stack to be cut, these approaches come at the cost of increased maintenance and decreased throughput, and are thus undesirable for large scale operations, such as national banks, which have to print very large quantities of security documents.

Thus, optimizing security documents for defect-free bulk cutting, in particular, defect-free cutting in the region where an applied security feature meets the cut edge of the security document, likewise presents a source of technical challenges and opportunities for improvement in the art.

Additionally, the challenges associated with manufacturing security documents include, without limitation, hardening such documents against “harvesting,” which refers to the process whereby malicious actors break down an authentic security document in order to remove hard-to-reproduce components of the security document intact, providing a mechanism by which malicious actors can obtain materials to produce counterfeit security documents. If removed substantially intact, hard-to-reproduce components of security documents, such as optical security devices (for example, security strips and patches) or parts of a fibrous substrate supporting the optical security devices can, for example, be used to create up-cycled counterfeits. As one example, the security thread from a lower denomination banknote may be incorporated into a forgery of a higher denomination banknote or multiple counterfeits (for example, by using pieces of an embedded security thread from an authentic banknote to produce two or more counterfeit notes). While counterfeit security documents produced from harvested components can typically be identified by central banks and security document professionals, to the extent they provide visible indicia of authenticity which substantially matches those of authentic documents, such counterfeits are of serviceable quality to malicious actors in that they can readily pass for authentic security documents to everyday users.

As improvements in the printing and scanning technologies required to produce “good enough” or “street quality” facsimiles of the printed features on a paper substrate of a security document continue to be commodified and made available to the general public, “harvesting” of micro-optic security features, has become a source of particular concern. Criminals and malicious actors are resourceful and have developed a variety of techniques for removing security features from security documents. Such techniques include “wet harvesting,” wherein the security document is soaked in a solvent (for example, water or alcohol) to loosen the adhesive bond between the security feature and substrate, as well as “dry harvesting,” wherein the document is not soaked, but rather, a malicious actor seeks to carefully peel off a surface-mounted security feature (such as a security thread). Given the resourcefulness of malicious actors, and improvements in imaging technology, hardening security documents against dry harvesting, as well as wet harvesting, by making it difficult to harvest security features substantially intact (and thus suitable for use in counterfeits) remains a source of technical challenges and opportunities for improvement in the art.

The non-limiting examples of FIGS. 1A-1D illustrate a document defect known as a “nail defect” which can arise when bulk cutting security documents. FIG. 1E illustrates aspects of an uncut sheet of security documents giving rise to the “nail defects” shown in FIGS. 1A-1D. For convenience of cross-reference, elements common to FIGS. 1A-1E are numbered similarly.

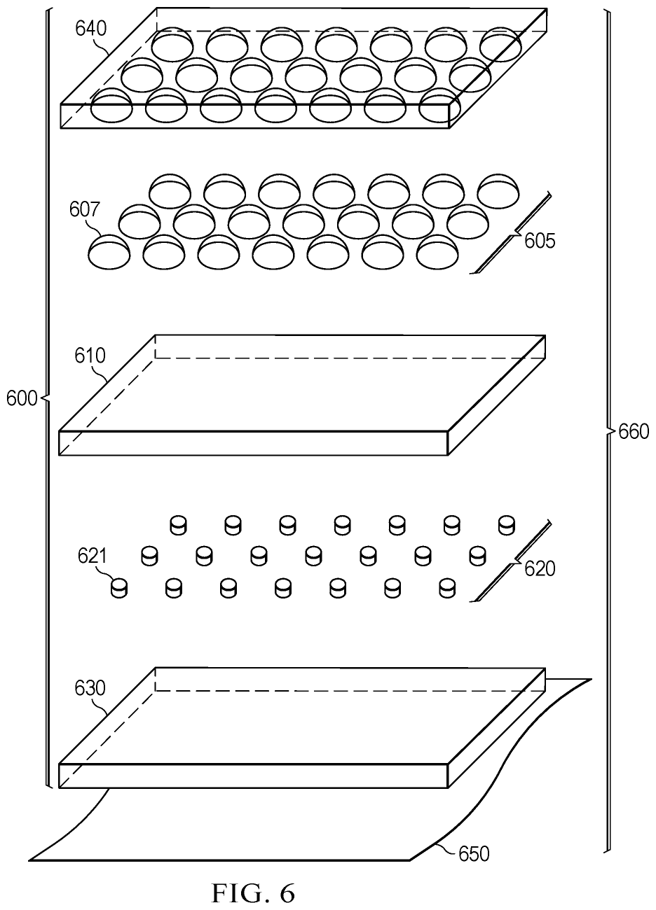

Referring to the illustrative example of FIG. 1A, a portion of a security document 100 (in this case, a currency banknote) is shown, while FIGS. 1B and 1C provide more detailed views illustrating the nail defects visible in FIG. 1A. FIGS. 1A-1D are photographs of security documents produced in a bulk run, wherein a belt of one hundred sheets of uncut security documents was cut using an industrial guillotine cutter. Industrial guillotines and die cutters suitable for cutting belts of security document typically exert cutting forces between 150-650 dekanewtons (“daN”). Security document 100 comprises a fibrous substrate 105, which, in this example, comprises a linen-cotton fiber blend interspersed with colored fibers, of similar weight and thickness to the fibrous substates used for U.S. currency notes. Security document 100 further comprises intaglio print features 110, and a surface applied security feature 115 (a security feature of similar construction to optical security device 600 in FIG. 6). In this example, surface applied security feature 115 comprises a ribbon of clear optical spacer material with a resinous lens layer on one side of the optical spacer, and a resinous icon layer disposed on the opposite side of the micro-optic spacer. As shown in the figure, surface applied security feature 115 and fibrous substrate 105 have been cut together, such that edge 117 of surface applied security feature 115 is co-extensive with that of security document 100.

In this example, there is no functional edge watermark where surface applied security feature 115 terminates at edge 117. As such, during the process of cutting security document 100 from a sheet (for example, uncut sheet 150 in FIG. 1E) in a belt of uncut sheets, the guillotine blade experiences a local maximum in the resistance from the belt of documents as the cut line reached the stacked micro-optic security devices in the belt. This sudden discontinuity in the resistance presented to the cutting tool by the belt of uncut sheets creates a wrinkling or deformation effect, known as the “nail defect” wherein the incompressible/less readily deformable material near edge 117 is bent over an internal die formed by the stacked micro-optic security devices in the belt. As the number of sheets in the belt increases, the effective size of this internal die increases, and the edge effect becomes more pronounced, particularly among documents near the top (i.e., closer to the side of the belt which first contacts the guillotine).

FIG. 1B provides a detailed view of the “nail defect” deformation of security document 100 located along edge 117 at the top of the security document of FIG. 1A. Fibrous substrate 105 and surface applied security feature 115 are visibly pinched or wrinkled resulting in a creased region across and extending beyond edge 117 of security document 100. Additionally, the nail defect of FIG. 1B creates an indented depression at edge 117 that degrades or destroys the flatness of security document 100, thereby adversely affecting the appearance of security document and interfering with the ability to stack and band batches of security documents for transit and storage. In addition to difficulties in maintaining an orderly stack, the lack of planarity of security document 100 can lead to jamming issues during the processing of a plurality of security documents via a high-speed banknote machine or adversely affect acceptance of the security document by automated banknote machines such as ATMs or payment stations.

Referring to the example of FIG. 1C, the deformation of security document 100 due to the above-described “nail defect” can be seen in the waviness along line 119, where the substrate and surface applied security feature 115 have been puckered inwards. As visible in FIG. 1C, edge 117 warps near the region of surface applied security feature 115 preventing a sharp, straight edge across the entirety of security document 100.

FIG. 1D provides a view of the opposite side of security document 100, as well as identical security documents 101 and 103. The defects of security documents 100, 101 and 103 are more visibly apparent, with the signature “nail defect” effect associated with the notes' deformation during cutting. Nail defect 197 is clearly visible on the upper edge of security document 100, as are associated nail defects 198 and 199 on the upper edges of security documents 101 and 103.

FIG. 1E illustrates an example of an uncut sheet 150 of security documents to demonstrate the regions at which the “nail defect” described with reference to FIGS. 1A-1D of this disclosure can appear and can be mitigated through the use of functional edge watermarks in accordance with this disclosure. Referring to the illustrative example of FIG. 1E, an uncut sheet of security documents (for example, banknotes, such as security document 100) is shown in the figure. As shown in the figure, uncut sheet 150 comprises a region 151 which has been printed with a repeating motif (represented by the grey shading), and to which (in this example) five ribbons of surface applied security feature material 153A-E have been applied. To form individual security documents (for example, security document 100), uncut sheet 150 is included in a belt (typically, though not necessarily, including 100 uncut sheets) of identical uncut sheets, which are then cut using an industrial guillotine along the cut lines shown as solid black lines in the figure (for example, cut line 157). As discussed elsewhere in this disclosure, “nail defects” (for example, nail defects 197-199 in FIG. 1D) typically appear in the intersectional regions (for example, region 159) where a cut line crosses an incompressible applied security feature. However, the tendency of nail defects to form in such intersectional regions can be reduced or arrested by providing one or more functional edge watermarks in accordance with this disclosure in such intersectional regions.

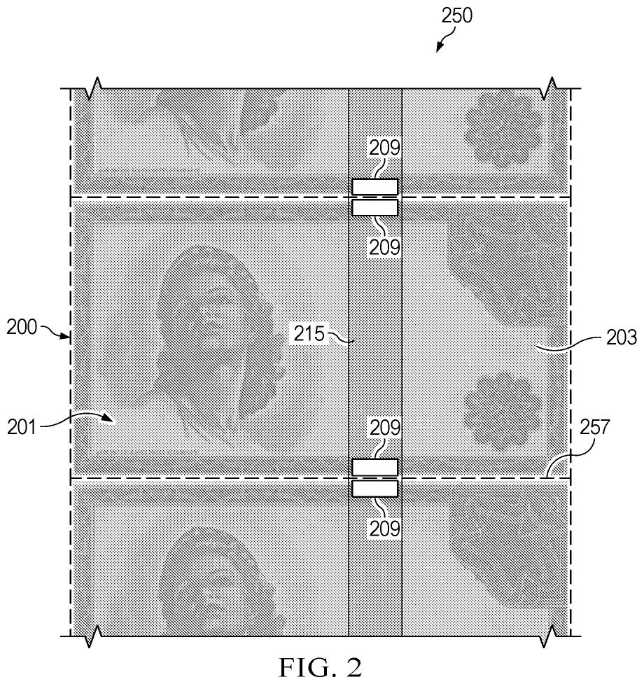

FIG. 2 illustrates a partial view of an uncut sheet of security documents as shown in transmitted light, comprising an exemplary functional edge watermark, which may also be referred to as a paper bright element, for eliminating the incidence of nail defects in bulk-cut (i.e., by guillotining a stack or belt of uncut sheets) when the functional edge watermark is aligned under a security feature such as a micro-optic thread.

As viewed in FIG. 2, uncut sheet 250 comprises a plurality of printed banknote security documents as example, security document 200. In some embodiments, security document 200 is comprised of a fibrous substrate 201 (for example, a linen or cotton fiber-rich paper), which includes a bulk portion 203 wherein the fiber density of the fibrous substrate is not locally altered (for example, through watermarking), and at least one functional edge watermark 209. In the example of FIG. 2, each functional edge watermark 209 (represented as white rectangles) is registered or aligned under security feature 215 and at each cut line 257. Functional edge watermark 209 is comprised of an area of locally altered fiber density wherein the fibrous substrate 201 composing the watermark has a lower fiber content than the surrounding fibrous substrate characterized by bulk portion 203. It is notable that the lower fiber content of the functional edge watermark 209 reduces the caliper of the substrate at the intersectional areas of uncut sheet 250 such as that indicated in region 159 of FIG. 1E. In some embodiments of this disclosure, locating the functional edge watermark under and within the perimeter of the security feature reduces the caliper of the fibrous substrate while allowing the security feature to add support to the reduced fiber region of the functional edge watermark while also improving harvest resistance of the security feature.

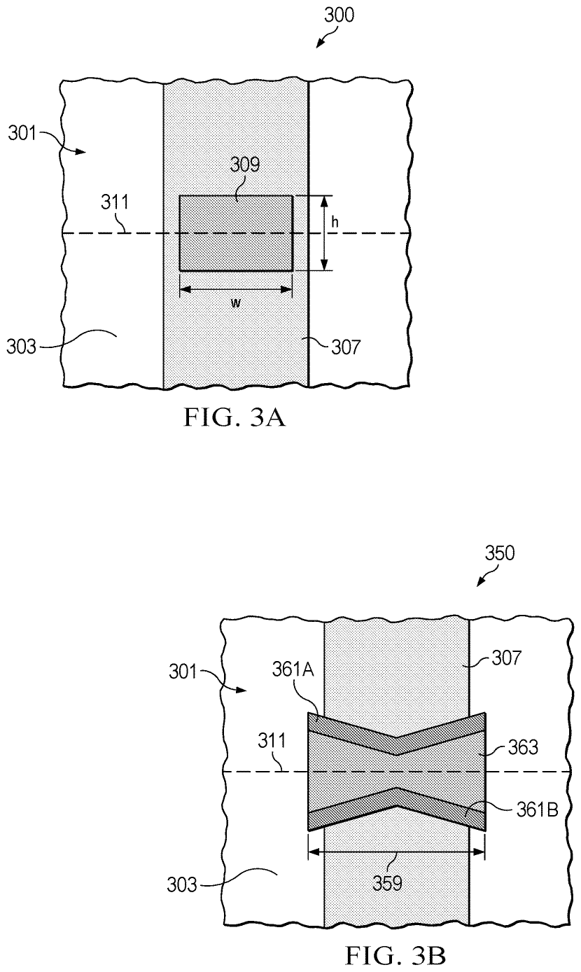

FIGS. 3A and 3B illustrate two examples of functional edge watermarks in accordance with this disclosure. For consistency and convenience of cross-reference, shading conventions, and item numbers common to both FIGS. 3A and 3B are shown the same in both figures.

Referring to the non-limiting example of FIG. 3A, a section of a first uncut sheet 300 (for example, uncut sheet 150 in FIG. 1E) of security documents is shown in the figure. In various embodiments, first uncut sheet 300 comprises a fibrous substrate 301, which includes a bulk portion 303 (shown in white in the figures). In some embodiments, bulk portion 303 has a thickness of 120 micrometers, though thicker and thinner embodiments are possible and within the contemplated scope of this disclosure. As shown in FIG. 3A, first uncut sheet 300 further comprises a surface applied security device 307 (for example, optical security device 600 in FIG. 6). In this example, applied security device 307 is formed as a multi-layered stack of light-curable resin and transparent film (for example, polyester film or BOPP) and has a width of approximately 12 mm, and a thickness between 35-50 micrometers. However, wider, narrower, thicker, and thinner instances of surface applied security device 307 are possible and within the contemplated scope of this disclosure.

As shown in FIG. 3A., first uncut sheet 300 further comprises a functional edge watermark 309. In various embodiments, the characteristic features of functional edge watermark 309 include one or more of the following:
a. Functional edge watermark 309 comprises a light region (shown as intermediate grey in the figure) straddling at least one cut line 311 along which individual security documents (for example, security document 200 in FIG. 2) are formed from first uncut sheet 300. In some embodiments, the light regions of functional edge watermark 309 are formed using an electrotype watermarking tool, for example, an electrotype tool such as described in U.S. Pat. No. 10,794,005. In certain embodiments, the light regions of functional edge watermark 309 are formed using a wire-mesh watermarking tool, likewise such as described in U.S. Pat. No. 10,794,005.
b. Functional edge watermark 309 consistently occupies at least half of the width (shown as w in the figure) of surface applied security device 307 along cut line 311. In some embodiments, this criterion may be met through one or more of improving the registration accuracy by which functional edge watermark 309 is applied or increasing width w as necessary.
c. In some embodiments, functional watermark 309 has a height (shown as h in FIG. 3A) at least equal to the vertical registration accuracy (for example, if the center of functional edge watermark 309 can only be aligned with cut line 311 to within 2 mm, then functional watermark has a height of 2 mm) of the tooling for providing functional edge watermark 309. In certain embodiments, functional watermark 309 has a height of at least 1.25 times the vertical registration accuracy of the watermarking tooling. In various embodiments, functional watermark 309 has a height at least equal to 1.5 times the vertical registration accuracy of the watermarking tooling. In certain embodiments, functional watermark 309 has a height equal to or greater than 1.5 times the vertical registration accuracy of the watermarking tooling.

FIG. 3B illustrates a further example of a functional edge watermark 359 in accordance with this disclosure. Referring to the non-limiting example of FIG. 3B, functional edge watermark 359 is provided on a section of uncut sheet 350, which includes compressible fibrous substrate 301, bulk portion 303, surface applied security device 307 and cut line 311, as described with reference to FIG. 3A. While certain embodiments of the present disclosure provide that, to mitigate nail defects, the compressibility of the uncut sheet under surface applied security device 307 be increased by reducing the fiber density with a functional edge watermark comprising a light area as described with reference to FIG. 3A, this does not imply that embodiments of functional edge watermarks for alleviating nail defects of the present disclosure cannot also include dark areas (i.e., areas of increased fiber density). Provided that the functional edge watermarks sufficiently lower the variation in deformation during cutting of uncut sheet 350 between the bulk portion 303 and the area where surface applied security device 307 meets cut line 311, functional edge watermark 359 can include one or more dark regions 361A and 361B of increased fiber density. However, in certain embodiments, functional edge watermark 359 defines a region in which the average fiber density is sufficiently reduced relative to the bulk portion 303, sufficient to offset the local variations in the deformability of uncut sheet 350 created. In various embodiments, one or more dark regions 361A and 361B are of lesser total area than light region(s) 363. In some embodiments, the one or more dark regions 361A and 361B are substantially parallel to cut line 311. In certain embodiments, the one or more dark regions 361A and 361B approach or cross cut line 311. Additionally, in certain embodiments, one or more dark regions 361A and 361B are not disposed under the center of (or substantially between the edges of) surface applied security device 307.

FIG. 4 illustrates an example method 400 for producing nail defect-free security documents in accordance with this disclosure. While the steps described with reference to FIG. 4 are described sequentially, the order of steps may be reversed, the steps may occur simultaneously or near simultaneously, and additional steps can be added.

Referring to the illustrative example of FIG. 4, at step 405, one or more functional watermarks are formed on a fibrous substrate. In various embodiments, the fibrous substrate comprises a sheet of cellulosic material, such as paper made of wood, linen and/or cotton fibers. The functional watermarks comprise light or “bright” regions having lower fiber density than the baseline fiber density of the bulk portion (i.e., the unwatermarked portion) of the fibrous substrate. In certain embodiments, the functional watermarks may also comprise some dark elements, but the net effect of the functional watermark is to lower the mean local fiber density in the area of the functional watermark relative to the fiber density of a bulk portion of the fibrous substrate. In this way, the localized variations in the deformability created by the addition of a surface-applied security device are mitigated, and bulk portion and functional watermark regions exhibit similar aggregate deformation properties and cut substantially similarly to a homogenous sheet of material.

As shown in FIG. 4, at step 410, a security feature (for example, a ribbon of micro-optic thread, such as optical security device 600 in FIG. 6) is applied to the fibrous web to form an uncut sheet of security documents. In some embodiments, the security feature is applied while the fibrous substrate is still forming from a wet slurry of fibers. In embodiments, the security feature may be applied to a fully dried fibrous substrate, thereby minimizing the likelihood of unpredictably altering the fiber density in the vicinity of the fibrous substrate through application of the security feature.

In various embodiments, at step 415, a stack of uncut sheets of security documents formed according to various embodiments of this disclosure are stacked together to form a belt of uncut sheets. In certain embodiments, the belt of uncut sheets comprises 100 uncut sheets, and the sheets are identically oriented in the stack such that the applied security features align along a line normal to the face (i.e., the flat upper surface where a cutting tool makes initial contact with the belt) of the belt.

In some embodiments, at step 420, the uncut sheets are then cut using an industrial guillotine or die cutter along one or more cut lines which traverse the applied security features at locations where the applied security features at least partially cover the functional watermarks. In some embodiments, a compressive force applied during cutting uncut sheets is between 150-600 dekanewtons (“daN”) and does not produce a nail defect in the cut security documents, thanks to the functional watermark offsetting local variations in deformability of the stack of documents in the belt caused by the presence of the applied security features. As noted elsewhere in this disclosure, the functional watermark helps homogenize the cutting properties of each sheet in the stack across the length of the cut line.

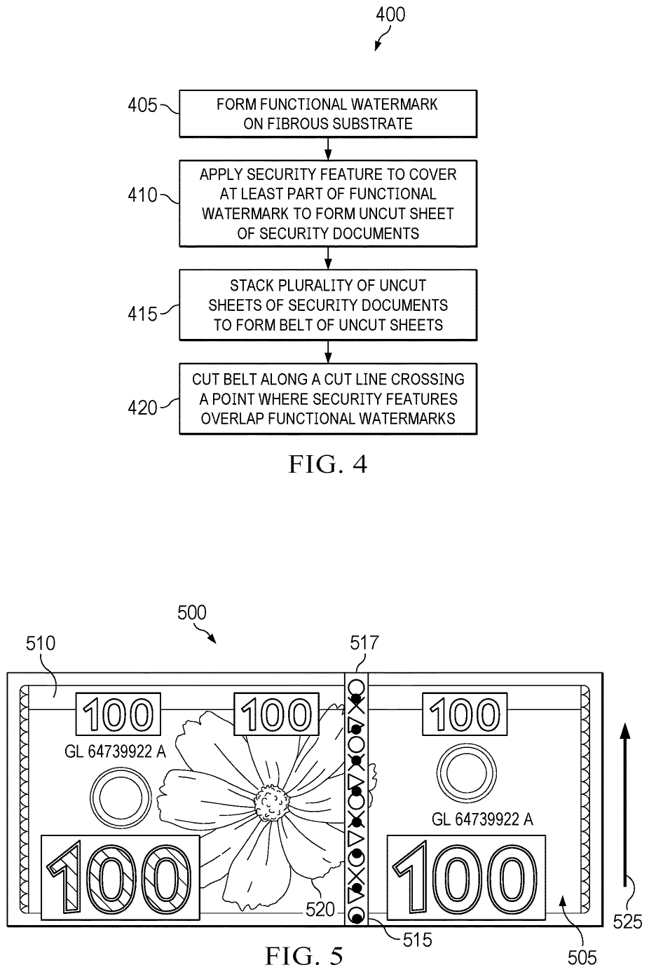

FIG. 5 illustrates an example of a security document in accordance with this disclosure. One of the operative premises behind harvesting security devices from authentic security documents is that the security feature needs to be separated from the substrate of the authentic document in a substantially intact condition suitable for reuse in a counterfeit document. Another operative premise is that new security devices and security documents be completely uniform in appearance, and without visible defects or variations due to manufacturing issues.

Where possible, counterfeiters also seek to preserve the substrate from which the security device is harvested. Put differently, visibly damaged security features and substrates are unusable for reuse in counterfeits. Additionally, imperfect originals inject uncertainty into the critical question of whether differences between documents are indicia of forgery. As discussed in greater detail herein, some embodiments of this disclosure minimize the likelihood of surface-applied security features being harvested, and, in particular, dry harvested without damage. More specifically, some embodiments of this disclosure increase the likelihood that a thin, multi-layered security feature will be damaged in response to mechanical harvesting (i.e., attempts to break the security feature-substrate bond mechanically, rather than thermal or chemical harvesting, wherein the security feature-substrate bond is attacked with heat or solvents), by using variations in the fiber densities in a watermarked region to cause sharp discontinuities in the local force upon the security feature being harvested along a separation line.

As many security features are constructed of thin (for example, between 50-150 microns total thickness) material with arrays of micro-scale features (for example, lenses or icon structures), harvesting, and especially dry harvesting, security features is a delicate operation generally premised on the steady application of a relatively constant peeling force. As used in this disclosure, the expression “peeling force” refers to a force applied to a security feature which has a first component parallel to the substrate (i.e., a “pulling force,” which generates tension in the security feature and causes a separation line between the security feature and the substrate to propagate along a peel direction”) and a second component perpendicular to the substrate (i.e., a “lifting force,” which breaks one or more adhesive or structural bonds between the security feature and the substrate, within the security feature, and/or within the substrate along the separation line).

Put differently, given the thinness and delicacy of the optical structures of many micro-optic security features, tugging on a security thread, or otherwise applying jerky, discontinuous, or excessive peeling force dramatically increases the likelihood of the security thread being damaged during harvesting, and thus unsuitable as components for counterfeit security documents. As discussed herein, some embodiments of functional watermarks of the present disclosure facilitate sufficiently abrupt variations in the peeling force applied to adhered security device during harvesting as to reliably cause the security device to tear, delaminate, or otherwise become unsuitable as a harvested component for re-use in a counterfeit security document.

Referring to the non-limiting example of FIG. 5, an example of a security document 500 in accordance with this disclosure is shown. In this illustrative example, security document 500 is a currency note, though other embodiments (for example, tickets, identification papers, etc.) are within the contemplated scope of this disclosure. In some embodiments, security document 500 comprises a fibrous substrate 505, which is formed from a wet web of fibrous material (for example, wood pulp, cotton fiber, linen fiber, flax fiber, sisal fiber, hemp fiber, Abaca fiber, Kozo fiber, Mitsumata fiber, bamboo fiber, Kenaf fiber and/or synthetic fiber), which is laid down (for example, in a Fourdrinier process) at a first, baseline fiber density. Regions of the web in which the first fiber density is not altered while the web is wet (for example, through the use of wire rolls, electrotypes, or other watermarking tools) prior to pressing, drying and in some embodiments, calendaring, form bulk region 510 of security document 500. As used in this disclosure, the expression “bulk region” encompasses a portion of a fibrous substrate embodying one or more of a baseline fiber density, baseline light absorption, or baseline caliper thickness. Put differently, as used in this disclosure, the expression “bulk region” encompasses portions of a finished fibrous substrate in which the locations of the constituent fibers are not deliberately altered (for example, through the use of embossed wirecloth or electrotypes) as part of the papermaking process.

As shown in the explanatory example of FIG. 5, security document 500 further comprises one or more security features 515 adhered to the surface of security document 500. In some embodiments, security feature 515 comprises a strip of material that traverses the width (referring to the shorter dimension of a rectangular shaped object) of security document 500 and is coextensive with one or more edges 517 of security document 500. In some embodiments, fibrous substrate, and security feature 515 are cut at the same time, resulting in both being coextensive with edge 517. Security feature 515 comprises a thin section of material with one or more optical structures, such as structures comprising an embossed or cast-cured outer surface that provides an optically variable effect. Examples of optical structures provided on security feature 515 include, without limitation, micro-lenses, diffractive structures, and micro-optic icons. Examples of optically variable effects provided by the optical structures of security feature 515 include, without limitation, holograms, color shift effects, and synthetic images, characterized by the synthetic projection of portions of image icons across an array of image icons by focusing elements of an array of focusing elements, wherein the scale ratio (i.e., the ratio of the repeat period of the focusing elements to the repeat period of the image icons) is approximately 1.000.

Security document 500 further comprises one or more functional watermarks 520. In various embodiments, functional watermark 520 comprises one or more regions in which the fiber density of fibrous substrate 505 is deliberately altered (either increased or decreased) from the fiber density in bulk region 510 to form a visible pattern of light (i.e., allowing more light to pass in transmission through the fibrous substrate than bulk region 510) and/or dark (i.e., less light to pass in transmission through the fibrous substrate than bulk region 510) elements. Additionally, at least a portion of functional watermark 520 is covered by part of security feature 515, wherein security feature 515 is maintained in contact with functional watermark 520 by an adhesive bond. In various embodiments, functional watermark 520 contacting security feature 515 comprises one or more light or dark elements with edges that are substantially perpendicular to one or more peel directions 525 of security feature 515. As used in this disclosure, the expression “peel direction” encompasses a direction in which the separation of security feature 515 is propagated in a direction generally corresponding to a local minimum of the separation line. By lifting security feature 515 away from fibrous substrate 505 in a peel direction 525 substantially perpendicular to a separation line between security feature 515 and fibrous substrate 505, the total peeling force applied to fibrous substrate 505 is minimized. All other things being equal, malicious actors may be reasonably expected to attempt to harvest security feature 515 by separating security feature 515 from fibrous substrate 505 along peel direction 525, in order to minimize the force applied to security feature 515. Depending on its shape, security feature 515 may present more than one peel direction.

In some embodiments, functional watermark 520 comprises light areas (i.e., areas of reduced fiber density) in the vicinity of where security feature 515 meets edge 517. As discussed in greater detail herein, the presence of the light areas in functional watermark 520 produces a local reduction in the substrate mass of fibrous substrate which offsets the incompressibility of security feature 515 relative to fibrous substrate 505. As such, the presence of functional watermark 520 means that the force required to propagate a cut within a stack of uncut documents along edge 517 does not spike upwards when the cut meets security feature 515 as compared to the force required to cut a stack of uncut documents that lack functional watermark 520.

FIG. 6 illustrates constructional aspects of an example micro-optic security device (for example, surface applied security feature 115 in FIG. 1) comprising part of a security document in accordance with this disclosure.

Referring to the non-limiting example of FIG. 6, optical security device 600 comprises a plurality of focusing elements 605 (including, for example, focusing element 607), and an arrangement of image icons 620 (including, for example, image icon 621). In various embodiments, each focusing element of the plurality of focusing elements 605 has a footprint, in which one or more image icons of the arrangement of image icons 620 is positioned. Collectively, the focusing elements of the plurality of focusing elements 605 magnify portions of the arrangement of image icons 620 to produce a synthetic magnification effect (also referred to as “synthetic image”) wherein the individually microscopic image icons are collectively magnified by the plurality of focusing elements 605 to produce an image which dynamically reacts (for example, by appearing to move, or change colors) in response to shifts in viewing angle. Given the small scale and tight manufacturing tolerances of the constituent structures of optical security device providing the moiré magnification effect, many malicious actors are not able to produce counterfeit versions of the optical security device 600. Accordingly, optical security device 600 is, in many cases, a trusted visual indicium of a security document's (for example, security document 660) authenticity.

In some embodiments, the plurality of focusing elements 605 comprises a planar array of micro-optic focusing elements. In some embodiments, the focusing elements of the plurality of focusing elements 605 comprise micro-optic refractive focusing elements (for example, plano-convex or GRIN lenses). Refractive focusing elements of the plurality of focusing elements 605 are, in some embodiments, produced from light cured resins with indices of refraction ranging from 1.35 to 1.7, and have diameters ranging from 5 μm to 200 μm. In various embodiments, the focusing elements of the plurality of focusing elements 605 comprise reflective focusing elements (for example, very small concave mirrors), with diameters ranging from 5 μm to 50 μm. While in this illustrative example, the focusing elements of the plurality of focusing elements 605 are shown as comprising circular plano-convex lenses, other refractive lens geometries, for example, lenticular lenses, are possible and within the contemplated scope of this disclosure.

As shown in the illustrative example of FIG. 6, the arrangement of image icons 620 comprises a set of image icons (including image icon 621), positioned at predetermined locations within the footprints of the focusing elements of the plurality of focusing elements 605. In various embodiments, the individual image icons of arrangement of image icons 620 comprise regions of light cured material associated with the focal path of structured light (for example, collimated UV light) passing through the plurality of focusing elements 605 from a projection point associated with one or more predetermined ranges of viewing angles. In some embodiments, the individual image icons of arrangement of image icons 620 are not provided within a structured image icon layer. As used in this disclosure, the term “structured image layer” encompasses a layer of material (for example, a light-curable resin) which has been embossed, or otherwise formed to comprise structures (for example, recesses, posts, grooves, or mesas) for positioning and retaining image icon material. In various embodiments, the individual image icons of the arrangement of image icons 620 are provided within a structured image layer, the structured image layer comprising one or more of voids, mesas, or posts, which act as retaining structures to hold micro- and nano-scale volumes of colored material.

As shown in the illustrative example of FIG. 6, in certain embodiments, the optical security device 600 includes an optical spacer 610. In various embodiments, optical spacer 610 comprises a film of substantially transparent material (for example, polyethylene terephthalate (“PET”) or Biaxially-Oriented Polypropylene (“BOPP”)) which operates to position image icons of the arrangement of image icons 620 in or around the focal plane of focusing elements of plurality of focusing elements 605. In some embodiments of this disclosure, the optical spacer 610 comprises a manufacturing substrate upon which one or more layers of light curable material can be applied, to form one or more of the arrangement of image icons 620 or the plurality of focusing elements 605.

In various embodiments, the optical security device 600 comprises one or more regions of light-cured protective material which occupy the spaces between the image icons of the arrangement of image icons 620. In some embodiments, the arrangement of image icons 620 is first formed (for example, by selectively curing and removing liquid light-curable material on optical spacer 610), and then a layer of clear, light-curable material is applied to fill spaces between the image icons of the arrangement of image icons 620 and then flood-cured to create a protective layer, which protects the image icons from being moved from their positions within the footprints of focusing elements of the plurality of focusing elements 605. In certain embodiments, the light-curable material used to form arrangement of image icons 620 is a pigmented, ultraviolet (UV)-curable polymer.

In some embodiments, the arrangement of image icons 620 is affixed to a second substrate 630, which operates to protect and secure the arrangement of image icons 620 and provide an interface for attaching optical security device 600 to a substrate 650 as part of security document 660. In some embodiments, optical security device 600 is affixed to substrate 650 during the manufacture of substrate in a paper-making machine, such as a Fourdrinier machine. In some embodiments, optical security device 600 is affixed to the substrate 650 by a layer of adhesive between the arrangement of image icons 620 and a top surface of the substrate 650.

In some embodiments of this disclosure, the optical security device 600 comprises a seal layer 640. In certain embodiments, the seal layer 640 comprises a thin (for example, a 2 μm to 50 μm thick) layer of substantially clear material which interfaces on a lower surface, with focusing elements of the plurality of focusing elements 605 and comprises an upper surface with less variation in curvature (for example, by being smooth, or by having a surface whose local undulations are of a larger radius of curvature than the focusing elements) than the plurality of focusing elements 605. In various embodiments, one or more of the plurality of focusing elements 605, the seal layer 640, and the arrangement of image icons 620 are formed from polyacrylate or other UV curable resin.

While FIG. 6 provides one example of an optical security device, the present disclosure is not so limited. Other optical security devices which are susceptible to being damaged from being tugged upon or otherwise subjected to abruptly increasing force and include hard-to-reproduce micro- and nano-scale optical structures (for example, holograms, devices providing thin-film effects, devices producing diffraction-based optical effects) which provide harvesting targets for malicious actors are within the contemplated scope of this disclosure.

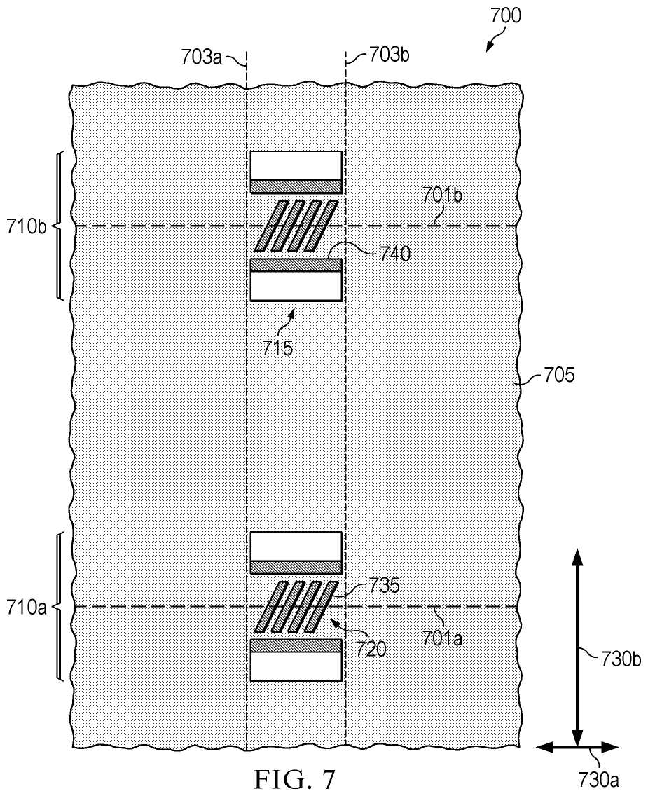

FIG. 7 illustrates an example of a fibrous substrate with functional watermarks in accordance with this disclosure. Referring to the non-limiting example of FIG. 7, an uncut section 700 of a fibrous substrate (for example, currency paper with linen fibers) is shown. In this example, uncut section 700 is to be cut along first cut line 701a and second cut line 701b to form substrates for one or more security documents. Additionally, at some point in the manufacturing process, one or more surface applied security features is applied to the fibrous substrate such that it covers the region bounded by first and second cut lines 701a and 701b and lines 703a and 703b. In some embodiments, the surface applied security feature is applied prior to cutting along cut lines 701a and 701b, such that cutting the fibrous substrate also trims the ends of the surface applied security feature to be flush with the edges of the security document. In some embodiments, the surface applied security feature is applied subsequent to slicing along cut lines 701a and 701b.

As shown in FIG. 7, uncut section 700 comprises a bulk region 705 making up the fibrous substrate (shown in grey in the figure), in which the fiber density and caliper of the fibrous substrate does not vary significantly and wherein transmitted light passes through the fibrous substrate uniformly across bulk region 705. In plain terms, the underlying paper (excluding any applied printing or security devices) in bulk region 705 appears to the human eye to be a uniformly opaque field of material.

In various embodiments, uncut section 700 further comprises first functional watermark 710a and second functional watermark 710b, which, in the example of FIG. 7, straddle first cut line 701a and second cut line 701b. As shown in FIG. 7, both first and second functional watermarks 710a and 710b comprise a pattern of dark elements (shown in dark grey in the figure) and light elements (shown in white in the figure). In various embodiments, light elements (for example, light element 715) correspond to regions of the fibrous substrate in which the wet web was altered during manufacture to yield lower fiber densities (i.e., fewer fibers per unit of area) than bulk region 705. As such, when viewed in transmitted light (i.e., when uncut section 700 is backlit), the light elements allow more light to pass through and appear lighter than bulk region 705. In some embodiments, light element regions comprise 50% to 70% of the background basis weight. In some embodiments, light element regions comprising 55% to 65% of background basis weight provide a high-performing combination of fibrous substrate strength and compressibility over the bulk region in the light element region. Similarly, dark elements (for example, dark element 720) correspond to regions of the fibrous substrate in which the wet web was altered during manufacture to yield higher fiber densities than bulk region 705 and allow less light to pass through than bulk region 705. As such, the dark elements appear darker in transmitted light than bulk region 705.

Additionally, in some embodiments, the local topology of uncut section 700 may vary significantly across functional watermarks 710a and 710b, with dark element high points (as recorded by placing a platen over each of functional watermarks 710a and 710b) relative to bulk region 705 and low points (again detected by comparing the profile of a watermark against a platen) relative to bulk region 705 across light elements. In various embodiments, the variations in caliper differential (wherein caliper measurements provide measurements of the local thickness at points within uncut section 700) between the high points of dark elements and low points of light elements approximates or is comparable to the thickness of a surface applied security feature. As such, where an area of altered fiber density (i.e., a light element or dark element) has a defined boundary, such as an edge, the variation in thickness between areas of altered fiber density can create small, localized slopes sufficient to cause fluctuations in the peel angle (i.e., the angle between the removed security feature and the surface of the fibrous substrate at the separation point). Such fluctuations in the peel angle vary the extent to which the applied peeling force is in a direction perpendicular to the fibrous substrate. In effect, the separation line abruptly fluctuates between progressing “uphill” and “downhill” as a malicious actor attempts to peel an adhered security feature away from functional watermarks 710a and 710b. These abrupt fluctuations in the peel angle across the transitions between light and/or dark elements translate into abrupt changes in the lifting and pulling components of the force applied to the security feature. As noted elsewhere in this disclosure, successful harvesting is generally premised on minimizing and holding the pulling and lifting components of the force applied to the security feature steady. Fluctuations in either the total force or the relative values of the pulling and lifting components are likely to damage the fibrous substrate and/or security feature, rendering one or both unsuitable for reuse in making counterfeit documents, or if re-used, will present visible indicia of prior tampering.

Referring to the illustrative example of FIG. 7, light element 715 and dark element 720 define regions that have one or more edges substantially perpendicular to one or more peel lines. In the explanatory example of FIG. 7, to minimize the length of the separation line (and by implication, the total force peeling force applied to the security feature), the logical approach for harvesting a surface applied security feature occupying the region bounded by lines 703a and 703b and cut lines 701a and 701b, would be to initiate harvesting by peeling up the security feature at a first corner in a first peel direction 730a, and having separated a second corner, harvest the security feature along its length by trying to propagate the separation by applying a peeling force in a second peel direction 730b.

Given that the geometry of the region bounded by lines 703a and 703b and cut lines 701a and 701b dictates first peel direction 730a and second peel direction 730b are the logical path for minimizing separation line width and applied force upon the security feature during a harvesting attempt, dark element 720 comprises regions having one or more edges (for example, first edge 735) disposed at an angle substantially perpendicular to first peel direction 730a. Testing has shown that, by providing at least one edge of a dark or light element of a functional watermark in a direction substantially perpendicular to a peel direction, the abruptness of discontinuities in the amount and directionality can be maximized, thereby maximizing the likelihood of damaging either the security feature or the substrate. Similarly, light element 715 has a second edge 740, that is substantially perpendicular to second peel direction 730b. By making at least one edge of a transition between different fiber densities substantially perpendicular to the peel direction, the effect of the abrupt change in slope, and in some cases, adhesion between the security feature and substrate is experienced across much, if not all, of the separation line, thereby maximizing the fluctuation in applied force, and by implication, the likelihood of damaging either the security feature or the substrate during harvesting.

While certain embodiments of this disclosure have been described with reference to FIG. 7's example of a ribbon-shaped security feature and functional watermarks disposed at the edges of a security document, the present disclosure is not limited thereto. Other combinations of functional watermarks (for example, functional watermarks having only light elements or only dark elements) and security documents (for example, security documents with functional watermarks disposed away from the edges) are within the contemplated scope of this disclosure.

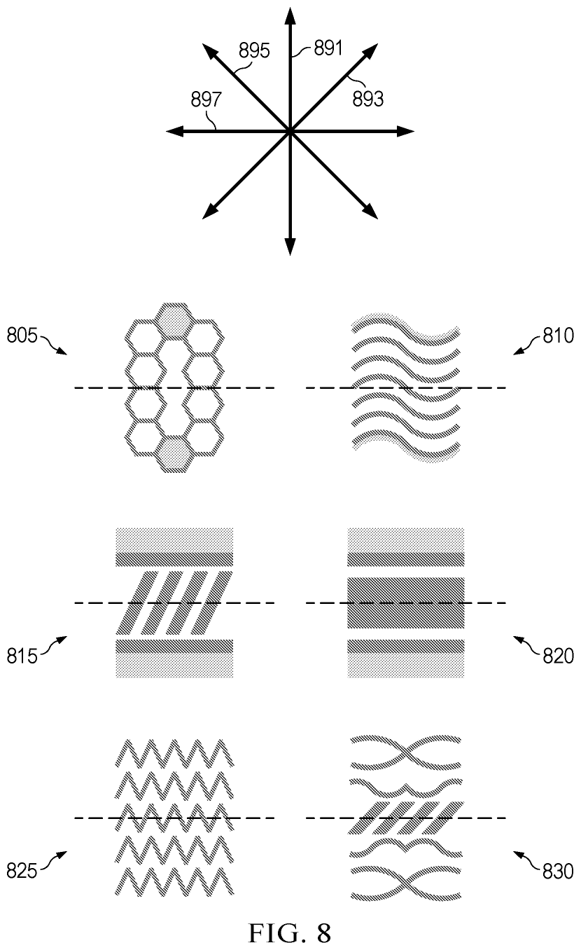

FIG. 8 illustrates a non-exhaustive set of six examples of functional watermark patterns suitable for use in security documents in accordance with this disclosure. Other functional watermark patterns suitable for use in security documents are possible and within the contemplated scope of this disclosure. In the illustrative examples of FIG. 8, a white field shows regions of a functional watermark in which the fiber density of a fibrous substrate is the same as that of bulk regions of a security document. A grey field shows regions of a first fiber density, wherein the first fiber density is altered during manufacture of a fibrous substrate to be higher or lower than the fiber density of the bulk region. In FIG. 8, black color indicates regions of a second fiber density, wherein the second fiber density is altered during manufacture of the fibrous substrate to be higher or lower than the fiber density of the bulk region, and to be different than the first fiber density.

Referring to the non-limiting example of FIG. 8, a first functional watermark pattern 805 comprises a honeycomb-shaped lattice of regions of the second fiber density, interspersed with fill regions of the first fiber density. The hexagonal shape of the individual cells of first functional watermark pattern present edges that are substantially perpendicular (for example, presenting an edge-peel direction angle of 45 degrees or greater) to a plurality of peel directions, including first peel direction 891, second peel direction 893 and third peel direction 895. In this regard, first functional watermark pattern 805 may be suitable for applied security features with a low aspect ratio (wherein the aspect ratio encompasses a ratio of a width to a length of the security device) and may be susceptible to harvesting across multiple peel angles.

As shown in the explanatory example of FIG. 8, second functional watermark pattern 810 comprises a series of wavy lined regions of first and second fiber densities. In some embodiments, second functional watermark pattern is effective for applied security features with a high aspect ratio, which can be reasonably be expected to be harvested by forces applied substantially parallel to first peel direction 891.

Third functional watermark pattern 815 embodies the same pattern as functional watermarks 710a and 710b in FIG. 7. In some embodiments, third functional watermark pattern 815 may be effective at creating discontinuities across multiple peel directions, such as fourth peel direction 897 and first peel direction 891, and thus may be particularly suitable for applications involving security devices with a high aspect ratio (for example, thread-shaped devices) with exposed corners (for example, where the thread is not buried beneath a second fibrous layer of substrate).

Fourth functional watermark pattern 820 comprises a series of broad horizontal bands of fibers altering the first and second fiber densities. Testing has shown that, in addition to the perpendicularity of leading edges of features of functional watermarks, the area of the regions of altered fiber density can be a factor affecting the extent to which features of a functional watermark improve harvesting resistance by catalyzing abrupt shifts in the quantity and directionality of a peeling force. Testing to date has indicated that high harvesting resistance (for example, dry harvest scores of 10-15 according to the U.S. Bureau of Engraving and Printing's harvesting resistance index) can be achieved when the area of the constituent regions of altered fiber density (i.e., light elements or dark elements) is between 60-140 mm². Fourth functional watermark pattern 820 may be particularly suitable in conjunction with narrow strips with a high aspect ratio, which present a single peel direction.

Fifth functional watermark pattern 825 comprises a spaced series of “zig zag” regions of the second fiber density separated by bulk regions. In addition to presenting substantially perpendicular edges to second, third, and fourth peel directions 893, 895, and 897, fifth functional watermark pattern 825 presents numerous variations in the topography of a fibrous substrate along first peel direction 891, which, though not perpendicular to first peel direction 891, can nonetheless create local discontinuities in the direction and force of a peeling force.

Sixth functional watermark pattern 830 presents similar performance as second functional watermark pattern 810 along first peel direction 891, but also incorporates elements of third functional watermark pattern 815 to provide harvesting resistance along fourth peel direction 897.

The six patterns described with reference to FIG. 8 are for illustration only, and functional watermarks having other patterns of light and/or dark elements with edged borders are possible and within the contemplated scope of this disclosure.

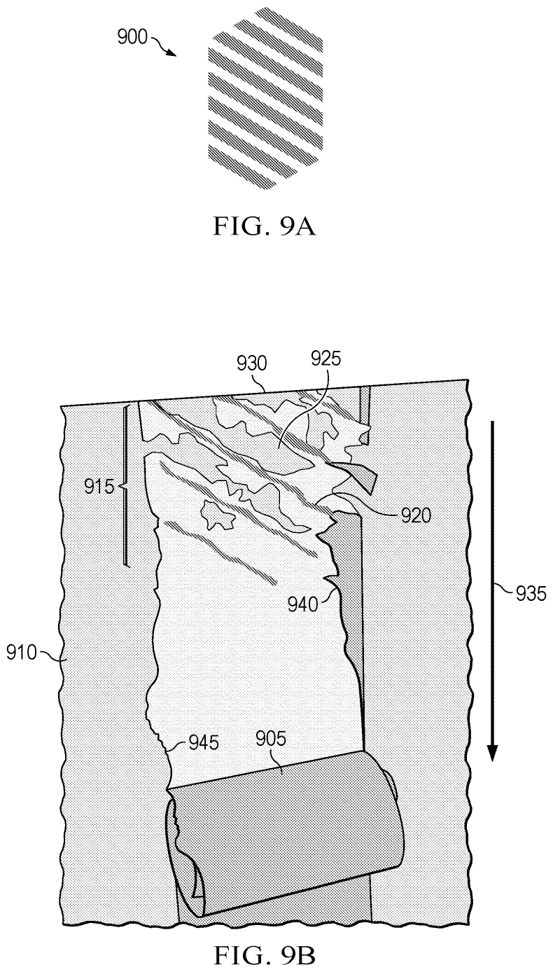

FIGS. 9A and 9B illustrate aspects of the harvesting resistance of a security document incorporating a functional watermark in accordance with this disclosure. For convenience of cross-reference, elements common to both FIGS. 9A and 9B are numbered similarly.

Referring to the non-limiting example of FIG. 9A, a functional watermark pattern 900 is shown in the figure. Functional watermark pattern 900 comprises a series of regions of altered fiber density (shown in black) interspersed among bulk regions of unaltered fiber density. FIG. 9B comprises a magnified image of a first damaged portion 905 of a security feature following an attempt to harvest it from a fibrous substrate comprising bulk region 910 as well as functional watermark 915, which embodies functional watermark pattern 900 of FIG. 9A. In this example, the regions of altered fiber density comprise dark elements, such as dark element 920, which appears darker than the adjacent stripe 925, which has substantially the same fiber density as bulk region 910. In this example, an attempt to harvest a security feature by initiating the peel at top edge 930 and moving in peel direction 935 was performed. As shown in FIG. 9B, the act of peeling the security feature away from functional watermark 915 caused discontinuities in the amplitude and/or directionality of the force applied to the security feature, initiating a tear in the security feature beginning at the rightmost portion of dark element 920, causing the micro-optic device to separate into a first damaged portion 905 and a second damaged portion 940. Additionally, in certain locations, the adhesive strength of the bond holding the fibrous substrate to the security feature was shown to exceed the internal strength of the fibrous substrate. For example, at location 945, patches of fibrous substrate are pulled away from a bulk region and remain attached to first damaged portion 905.

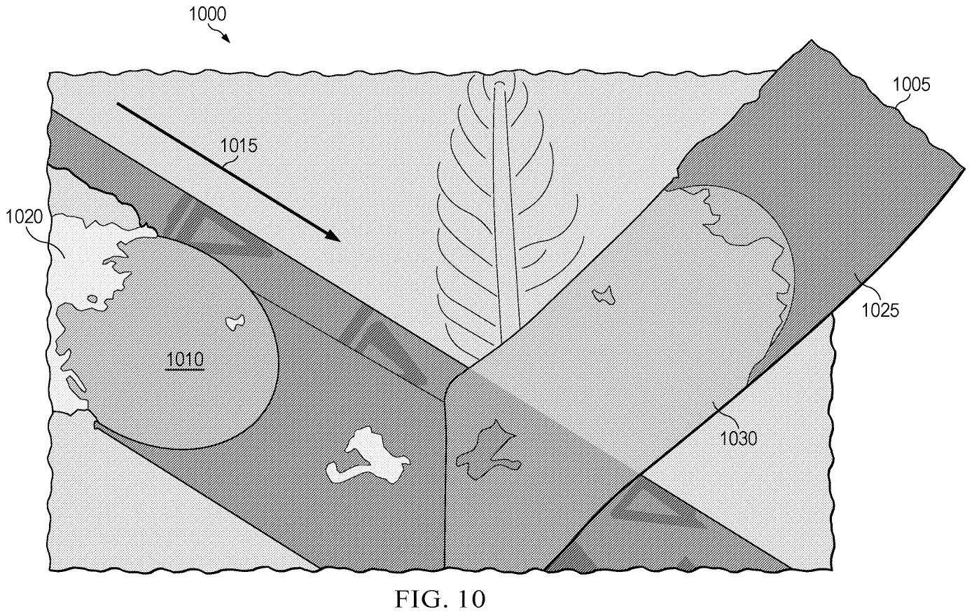

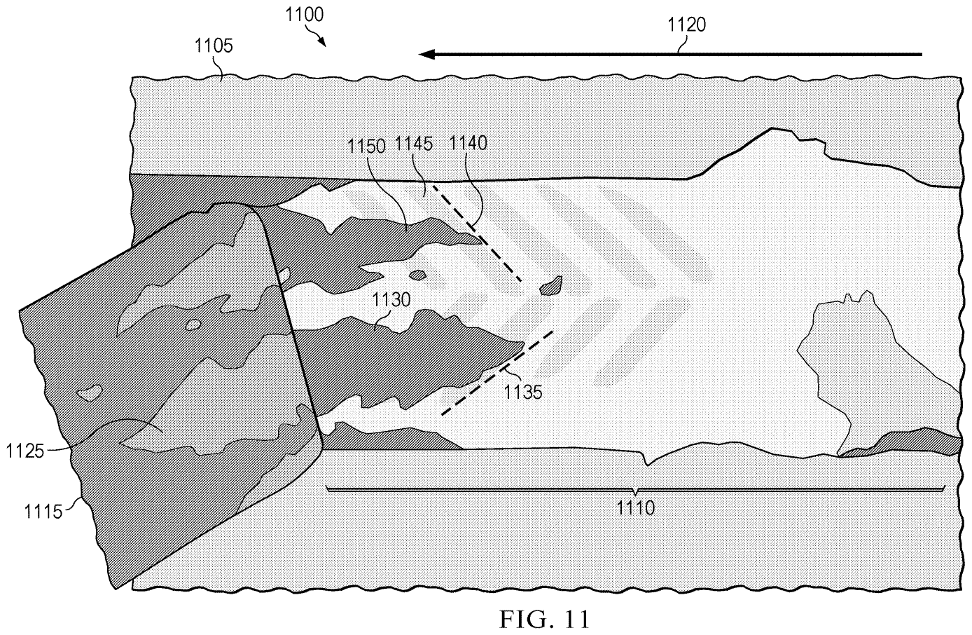

FIG. 10 illustrates an example image 1000 obtained after attempting to harvest a security feature 1005 from a security document comprising a functional watermark 1010, in accordance with this disclosure. Referring to the illustrative example of FIG. 10, security feature 1005 comprises a multi-layer micro-optic security feature comprising an optical spacer (for example, optical spacer 610 in FIG. 6), an array of focusing elements, in this case microlenses (for example, the array of focusing elements 605 in FIG. 6) and an array of image icons (for example, the arrangement of image icons 620 in FIG. 6). Security feature 1005 has been constructed through cast-curing, wherein the microlenses and image icons are formed in situ from material adhering to the optical spacer. In this non-limiting example, functional watermark 1010 has been formed as a circular region comprising a single light element in a fibrous substrate, in this case, currency paper comprising a mixture of paper and cotton or linen fibers. Functional watermark 1010 has been formed with an electrotype attached to a portion of an embossed wire cloth, though in certain embodiments, functional watermark 1010 can equally well be formed without using an electrotype or by using another suitable tool for locally altering fiber densities in a forming fibrous substrate.

As shown in FIG. 10, dry harvesting of security feature 1005 in peel direction 1015 was attempted. However, as the separation line crossed the perimeter 1020 of functional watermark 1010, the lifting component of the peel force exceeded the internal adhesion between the icon layer and the optical spacer, causing security feature 1005 to delaminate, with the icon layer remaining adhered to the fibrous substrate. As shown in FIG. 10, in an initial portion 1025 of security feature 1005, all of the layers of the security feature 1005 have been successfully harvested, as indicated by the dark tint of the removed material, indicating the presence of the colored icon layer. However, in a second portion 1030, roughly bounded by the point of contact between security feature 1005 and perimeter 1020 of functional watermark 1010, icon material is no longer present on the removed portion of security feature 1005, as indicated by the light, translucent appearance of security feature 1005 in second portion 1030.

FIG. 11 is an example section 1100 of a security document further illustrating how, in some embodiments of this disclosure, sharp-edged transitions between light or dark elements in a functional watermark provide initiation points for structural damage to surface applied features. Referring to the illustrative example of FIG. 11, the section 1100 of a security document in accordance with this disclosure is shown. The security document comprises a bulk region 1105 of a formed fibrous substrate, wherein the fibrous substrate is a currency paper comprising a blend of paper and linen or cotton fibers. In some embodiments, the fibrous substrate may comprise synthetic fibers (for example, machine-readable fibers) added for strength or to provide hard-to-reproduce indicia of authenticity. The security document further comprises a functional watermark 1110, comprising alternating bulk regions and light elements in a repeating chevron or “tire tread pattern.” For clarity and ease of reference, the edges of some of the boundaries between bulk regions and light elements of functional watermark 1110 have been highlighted in the figure. A multi-layer micro-optic security device 1115 (for example, optical security device 600) has been applied over and adhered to functional watermark 1110. As with security feature 1005 in FIG. 10, micro-optic device comprises, at a minimum, an upper layer of focusing elements adhered to an optical spacer, and a layer of icon elements adhered to the optical spacer on an underside of the optical spacer. In this example, dry harvesting of micro-optic security device 1115 by peeling it in peel direction 1120 was attempted.

As shown in FIG. 11, micro-optic security device 1115 experienced structural failure, specifically, delamination of the optical spacer layer from the icon layer during harvesting, as shown by the light region 1125 on a harvested portion of micro-optic security device 1115, and the similarly-shaped dark region 1130 remaining on the fibrous substrate. Taken together, light region 1125 and counterpart dark region 1130 indicate that the internal forces holding the icon layer of micro-optic security device 1115 to the optical spacer were overcome by the lifting component of the peeling force.

Notably, and as shown in FIG. 11, the leading edge of dark region 1130 corresponds exactly to first leading edge 1135 of a light element of functional watermark 1110, indicating an abrupt spike in the lifting component of the peeling force in the vicinity of the first leading edge 1135, initiating a structural failure in micro-optic security device 1115. While slightly less clear in section 1100, there is a similar correspondence between second leading edge 1140 of light element 1145, and the start of a second region 1150 of icon material remaining on the substrate. Additionally, the 45 degree angle between leading edges 1135 and 1140 to peel direction 1120 indicates that, while substantial perpendicularity between the peel direction and the edge of a region of altered fiber density is conducive to initiating abrupt changes in the lifting and peeling components of a peeling force (similar to how a square-bowed ship meeting an ocean wave decelerates more abruptly than a pointed-prow craft), it is by no means required for initiating structural failure of micro-optic security devices during harvesting.

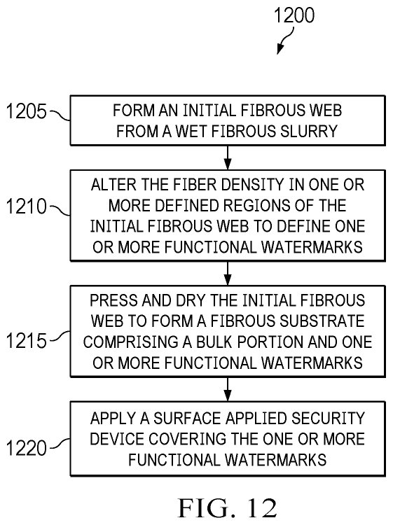

FIG. 12 illustrates an example method 1200 for forming a security document (for example, security document 500 in FIG. 5) in accordance with this disclosure. While the steps described with reference to FIG. 12 are described sequentially, the order of steps may be reversed, the steps may occur simultaneously or near simultaneously, and additional steps can be added. Referring to the non-limiting example of FIG. 12, at step 1205, an initial fibrous web is formed from a wet slurry, wherein the wet slurry comprises a mixture of, without limitation, fibrous material (for example, paper fibers, cotton fibers, linen fibers, or synthetic fibers) and water. The initial fibrous web may be formed by transferring the wet slurry from a forming vat onto the screen of a forming board. The initial fibrous web has sufficient water content (for example, 99% or more water by weight) that, after initial dewatering of the fibrous web, the constituent fibers of the slurry can, at later stages of the papermaking process (for example, at a wet press section) be relocated in response to “squeezing forces” applied to the web by one or more of a wire cloth on a dandy roll or an electro type tool.

At step 1210, the fiber density in one or more defined regions of the initial fibrous web is altered to define features of one or more functional watermarks. In some embodiments, the fiber density is altered through reduction, creating light elements of a functional watermark. In some embodiments, the fiber density is altered through addition, creating dark elements of the functional watermark. At step 1215, the initial fibrous web, including the regions of altered fibrous density, are pressed and dried (for example, by passing through the press and dryer sections of a Fourdrinier machine to form a dry, fibrous substrate with one or more functional watermarks (for example, uncut section 700 in FIG. 7). At step 1220, a surface applied security device (for example, optical security device 600 in FIG. 6) is applied to the fibrous substrate in at least one region covering the functional watermark to form a security document (for example, security document 500 in FIG. 5) in some embodiments of this disclosure.

Examples of security documents of the present disclosure include security documents comprising a fibrous substrate, the fibrous substrate including a functional watermark, the functional watermark including a defined region of altered fiber density relative to a bulk portion of the fibrous substrate, wherein the functional watermark comprises a first edge defining, or determining, at least in part, a shape of the defined region of altered fiber density; and a surface applied security device, the surface applied security device covering at least part of the defined region of altered fiber density relative to the bulk portion.

Examples of security documents of the present disclosure include security documents wherein the functional watermark is disposed along a cut edge of the fibrous substrate.

Examples of security documents of the present disclosure include security documents wherein the functional watermark is disposed away from a cut edge of the fibrous substrate.

Examples of security documents of the present disclosure include security documents wherein the first edge is substantially perpendicular to a first peel direction of the surface applied security device.

Examples of security documents of the present disclosure include security documents wherein the functional watermark comprises a second edge, determining at least in part a shape of the defined region of altered fiber density, and wherein the second edge is substantially perpendicular to a second peel direction of the surface applied security device.

Examples of security documents of the present disclosure include security documents wherein an area of the defined region of altered fiber density contacting the surface applied security device is between 60-140 mm².

Examples of security documents of the present disclosure include security documents wherein the surface applied security device comprises a multi-layer optical structure.

Examples of security documents of the present disclosure include security documents wherein the surface applied security device comprises the following layers: a first layer of focusing elements; and a second layer of icon elements, wherein the first layer of focusing elements projects a synthetic image of icon elements of the second layer of icon elements.

Examples of security documents of the present disclosure include security documents wherein the surface applied security device comprises a transparent optical spacer.

Examples of security documents of the present disclosure include security documents wherein the functional watermark comprises a repeating pattern of shapes defining regions of altered fiber density relative to the fiber density of the fibrous substrate.

Examples of security documents of the present disclosure include security documents wherein the surface applied security device is configured to experience structural failure in an area contacting the functional watermark in response to dry harvesting.

Examples of security documents of the present disclosure include security documents wherein the defined region of altered fiber density relative to the bulk portion of the fibrous substrate corresponds to an electrotype pattern.

Examples of security documents of the present disclosure include security documents wherein the defined region of altered fiber density relative to the bulk portion of the fibrous substrate corresponds to a wire mesh watermarking tool pattern.

Examples of security documents of the present disclosure include security documents comprising an adhesive layer disposed between the surface applied security device and the defined region of altered fiber density relative to the bulk portion of the fibrous substrate, wherein the adhesive layer provides an adhesive force between the surface applied security device and defined region of altered fiber density that is less than an internal force holding fibers of the fibrous substrate together.

Examples of security documents of the present disclosure include security documents comprising an adhesive layer disposed between the surface applied security device and the defined region of altered fiber density relative to the bulk portion of the fibrous substrate, wherein the adhesive layer provides a first adhesive force between the surface applied security device and the defined region of altered fiber density, and wherein the adhesive layer provides a second adhesive force between the surface applied security device and the bulk portion of the fibrous substrate.

Examples of security documents of the present disclosure include security documents wherein the defined region of altered fiber density comprises a light region of reduced fiber density and greater compressibility than the bulk portion.

Examples of security documents of the present disclosure include security documents wherein the defined region of altered fiber density comprises an electrotype watermark.

Examples of security documents of the present disclosure include security documents wherein the defined region of altered fiber density comprises a wire cloth watermark.

Examples of security documents of the present disclosure include security documents wherein the defined region of altered fiber density further comprises one or more dark regions of increased fiber density relative to the bulk portion of the fibrous substrate.

Examples of security documents of the present disclosure include security documents wherein the defined region of altered fiber density is 25-50 percent more compressible than the bulk portion of the fibrous substrate.

Examples of security documents of the present disclosure include security documents wherein the defined region of altered fiber density is 50-65 percent more compressible than the bulk portion.

Examples of security documents of the present disclosure include security documents where the defined region and surrounding areas do not exhibit a nail defect.

Examples of security documents of the present disclosure include security documents wherein the defined region has a height at least equal to a vertical registration accuracy of a tool for providing the functional watermark.

Examples of security documents of the present disclosure include security documents wherein when the security document is part of a one hundred sheet belt of identical security documents subjected to a cutting force of 300 daN, nail defects are not observed.

Examples of methods of the present disclosure include methods comprising forming an initial fibrous web from a wet fibrous slurry, altering the fiber density of the initial fibrous web in one or more defined regions to define one or more functional watermarks, pressing and drying the initial fibrous web to form a fibrous substrate comprising a bulk portion and the one or more functional watermarks, wherein the one or more functional watermarks comprise at least one of a light element or a dark element, the light element or dark element having at least one edge bounding a region of altered fiber density and applying a surface applied security device covering at least part of the one or more functional watermarks.

Examples of methods of the present disclosure include methods comprising cutting the fibrous substrate along a line crossing at least one functional watermark and the surface applied security device.

Examples of methods of the present disclosure include methods wherein the surface applied security device is applied to the initial fibrous web, prior to pressing and drying the initial fibrous web.

Examples of methods of the present disclosure include methods wherein the surface applied security device is applied to the fibrous substrate subsequent to pressing and drying the initial fibrous web.

Examples of methods of the present disclosure include methods wherein altering the fiber density of the initial fibrous web in the one or more defined regions is performed with at least one of an electrotype element or a wire cloth.

Examples of methods of the present disclosure include methods comprising, forming a functional watermark on a fibrous substrate, wherein the functional watermark comprises a defined region having a lower fiber density than an unwatermarked bulk portion of the fibrous substrate, applying a security feature to the fibrous substrate to form an uncut sheet of security documents, wherein the security feature covers at least part of the functional watermark and comprises a section of material having lower relative compressibility than the fibrous substrate, stacking a plurality of said uncut sheets to form a belt of uncut sheets such that the security features of the uncut sheets align along a line normal to a face of the belt, and cutting the belt of uncut sheets along a cut line crossing at a point where the security features overlap the functional watermarks to form individual security documents, wherein the individual security documents do not exhibit a nail defect at the point where the security features overlap the functional watermarks.

Examples of methods of the present disclosure include methods wherein the defined region of altered fiber density comprises an electrotype watermark.

Examples of methods of the present disclosure include methods wherein the defined region of altered fiber density comprises a wire cloth watermark.

Examples of methods of the present disclosure include methods wherein the defined region of altered fiber density further comprises one or more dark regions of increased fiber density relative to the bulk portion of the fibrous substrate.

Examples of methods of the present disclosure include methods wherein the defined region of altered fiber density is 25-50 percent more compressible than the bulk portion of the fibrous substrate.

Examples of methods of the present disclosure include methods wherein the defined region of altered fiber density is 50-65 percent more compressible than the bulk portion.

Examples of methods of the present disclosure include methods wherein the defined region has a height at least equal to a vertical registration accuracy of a tool for providing the functional watermark.

Examples of methods of the present disclosure include methods wherein when the belt comprises 100 uncut sheets and is subjected to a cutting force of 300 daN, nail defect is not observed.

Examples of methods of the present disclosure include methods wherein the security feature comprises multiple layers, the multiple layers including at least one of a transparent optical spacer, a resinous array of focusing elements or a resinous layer of image icons.

Although the present disclosure has been described with various embodiments, various changes and modifications may be suggested to one skilled in the art. It is intended that the present disclosure encompass such changes and modifications as falling within the scope of the claims.

1. A security document, the security document comprising:
a fibrous substrate, the fibrous substrate including:
a functional watermark including a defined region of altered fiber density relative to a bulk portion of the fibrous substrate, wherein the functional watermark comprises a first edge defining, at least in part, a shape of the defined region of altered fiber density; and
a surface applied security device covering at least part of the defined region of altered fiber density relative to the bulk portion.

2. The security document of claim 1, wherein the functional watermark is disposed along a cut edge of the fibrous substrate.

3. The security document of claim 1, wherein the functional watermark is disposed away from a cut edge of the fibrous substrate.

4. The security document of claim 1, wherein the first edge is substantially perpendicular to a first peel direction of the surface applied security device.

5. The security document of claim 4, wherein:
the functional watermark comprises a second edge, determining at least in part a shape of the defined region of altered fiber density; and
the second edge is substantially perpendicular to a second peel direction of the surface applied security device.

6. The security document of claim 1, wherein an area of the defined region of altered fiber density contacting the surface applied security device is between 60-140 mm².

7. The security document of claim 1, wherein the surface applied security device comprises a multi-layer optical structure.

8. The security document of claim 5, wherein the surface applied security device comprises the following layers:
a first layer of focusing elements; and
a second layer of icon elements,
wherein the first layer of focusing elements projects a synthetic image of icon elements of the second layer of icon elements.

9. The security document of claim 5, wherein the surface applied security device comprises a transparent optical spacer.

10. The security document of claim 1, wherein the functional watermark comprises a repeating pattern of shapes defining regions of altered fiber density relative to the fiber density of the fibrous substrate.

11. The security document of claim 1, wherein the surface applied security device is configured to experience structural failure in an area contacting the functional watermark in response to dry harvesting.

12. The security document of claim 1, wherein the defined region of altered fiber density relative to the bulk portion of the fibrous substrate corresponds to an electrotype pattern.

13. The security document of claim 1, wherein the defined region of altered fiber density relative to the bulk portion of the fibrous substrate corresponds to a wire mesh watermarking tool pattern.

14. The security document of claim 1, further comprising an adhesive layer disposed between the surface applied security device and the defined region of altered fiber density relative to the bulk portion of the fibrous substrate,
wherein the adhesive layer provides an adhesive force between the surface applied security device that is less than an internal force holding fibers of the fibrous substrate together.

15. The security document of claim 1, further comprising an adhesive layer disposed between the surface applied security device and the defined region of altered fiber density relative to the bulk portion of the fibrous substrate,
wherein the adhesive layer provides a first adhesive force between the surface applied security device and the defined region of altered fiber density, and
wherein the adhesive layer provides a second adhesive force between the surface applied security device and the bulk portion of the fibrous substrate.

16. A method of making a security document, the method comprising:
forming an initial fibrous web from a wet fibrous slurry;
altering a fiber density of the initial fibrous web in one or more defined regions to define one or more functional watermarks;
pressing and drying the initial fibrous web to form a fibrous substrate comprising a bulk portion and the one or more functional watermarks, wherein the one or more functional watermarks comprise at least one of a light element or a dark element, the light element or dark element having at least one edge bounding a region of altered fiber density; and
applying a surface applied security device covering at least part of the one or more functional watermarks.

17. The method of claim 16, further comprising cutting the fibrous substrate along a line crossing at least one functional watermark and the surface applied security device.

18. The method of claim 16, wherein the surface applied security device is applied to the initial fibrous web prior to pressing and drying the initial fibrous web.

19. The method of claim 16, wherein the surface applied security device is applied to the fibrous substrate subsequent to pressing and drying the initial fibrous web.

20. The method of claim 16, wherein altering the fiber density of the initial fibrous web in the one or more defined regions is performed with at least one of an electrotype element or a wire cloth.
